(19) United States
(12) Patent Application Publication
(10) Pub. No.: US 2007/0038694 A1
(43) Pub. Date: Feb. 15, 2007

(54) Method of root operation for voice recognition and mobile terminal thereof

(75) Inventor: Kyoung Ho Woo, Anyang-si (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/500,948

(22) Filed: Aug. 9, 2006

(30) Foreign Application Priority Data
Aug. 9, 2005 (KR) 10-2005-0072651

(51) Int. Cl. G06F 7/38

(52) U.S. Cl. 708/495

(57) ABSTRACT

A method of a root operation for voice recognition and mobile terminal thereof are disclosed, by which an operational speed faster than that of a Taylor series using method can be provided and by which a memory having a size smaller than that of a table using method is needed. The present invention includes the steps of transforming an inputted frame of prescribed bits into a multiplication of a mantissa part having a value equal to or greater than 1 under 1 and an exponential part having an even exponent, finding a root operation value of the mantissa part using both a linear interpolation technique and a table-using technique, finding a rot value of the exponential part, and outputting a multiplication of the mantissa part root value and the exponential part root value as a root value corresponding to the inputted frame of the prescribed bits.

This application claims the benefit of the Korean Patent Application No. 10-2005-0072651, filed on Aug. 9, 2005, which is hereby incorporated by reference as if fully set forth herein.

### BACKGROUND OF THE INVENTION

1. Field of the Invention

The present invention relates to a root operation method, and more particularly, to a method of a root operation for voice recognition and mobile terminal thereof. Although the present invention is suitable for a wide scope of applications, it is particularly suitable for implementing the voice recognition root operation.

2. Discussion of the Related Art

Generally, the remarkable developments of the information communication technology bring rapid transitions of information and communication environments. A mobile terminal capable of mobile communications such as a mobile phone and the like is regarded as a necessity in a modern society to be globally used. In order to meet the user's demand according to the base expansion of the mobile terminal, various functions including a dialing function via voice recognition as well as a general voice calling are provided to the mobile terminal.

For the voice recognition, it is essential to perform a digital signal processing through a function such as ‘cepstrum(frame)=inverse FFT(log|FFT(frame)|)’ for a feature vector extraction of an inputted voice signal. In this function, the frame means a voice signal sampled by 20 ms unit. The cepstrum function extracts a feature function from the samples voice signal. A human voice itself is easily distorted by noise. Yet, the feature vector extracted by the cepstrum function is characterized in being hardly distorted by the noise. So, the feature vector by the cepstrum is generally used as an input signal for voice recognition.

In order to operate ‘|FFT(frame)|’ of the cepstrum function, a root operation is essential. As a conventional root operation method, there is a method using Taylor series or a method using a table.

In the method using Taylor series, an inputted voice signal is represented as Taylor series and a root operation is then executed. Yet, since this method needs quite a lot of operations, a controller is overloaded to slow down a corresponding operational speed.

In the table-using method, a table containing a root value corresponding to each voice signal is stored in a memory and a root value corresponding to an inputted voice signal is found with reference to the stored table. This method just needs to find a specific root value from the table without executing the complicated operations, whereby its operational speed for a root operation is faster than that of the Taylor series using method.

However, if a value of an inputted voice signal is a 32-bit fixed-point number, the table should be provided with 2³² root values corresponding to 2³² voice signal values, respectively. Hence, to store these values, a memory having a considerably large capacity is needed.

### SUMMARY OF THE INVENTION

Accordingly, the present invention is directed to a method of a root operation for voice recognition and mobile terminal thereof that substantially obviate one or more problems due to limitations and disadvantages of the related art.

An object of the present invention is to provide a method of a root operation for voice recognition and mobile terminal thereof, by which an operational speed faster than that of a Taylor series using method can be provided and by which a memory having a size smaller than that of a table using method is needed.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of a root operation for voice recognition, includes: transforming an inputted frame of prescribed bits into a multiplication of a mantissa part having a value equal to or greater than 0 under 1 and an exponential part having an even exponent; finding a root operation value of the mantissa part using both a linear interpolation technique and a table-using technique; finding a rot value of the exponential part; and outputting a multiplication of the mantissa part root value and the exponential part root value as a root value corresponding to the inputted frame of the prescribed bits.

In another aspect of the present invention, a mobile terminal, which is capable of implementing a root operation, includes a root operation unit transforming an inputted frame of prescribed bits into a multiplication of a mantissa part having a value equal to or greater than 0 under 1 and an exponential part having an even exponent, the root operation unit finding a root operation value of the mantissa part using both a linear interpolation technique and a table-using technique, the root operation unit finding a root value of the exponential part, and the root operation unit outputting a multiplication of the mantissa part root value and the exponential part root value as a root value corresponding to the inputted frame of the prescribed bits.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic flowchart of a root operation method using a linear interpolation according to the present invention;

FIG. 2 is a graph for explaining a root operation method using a linear interpolation according to the present invention; and

FIG. 3 is a schematic block diagram of a mobile terminal capable of implementing a root operation method using a linear interpolation according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

First of all, a voice frame used in voice recognition of a mobile terminal corresponds to a 32-bit frame in general. For simplification and convenience of understanding the present invention, a voice frame inputted for a rot operation is explained in the following description on the assumption that the voice frame corresponds to an 8-bit frame. So, it should be noted that a scope of the present invention is not limited to this assumption.

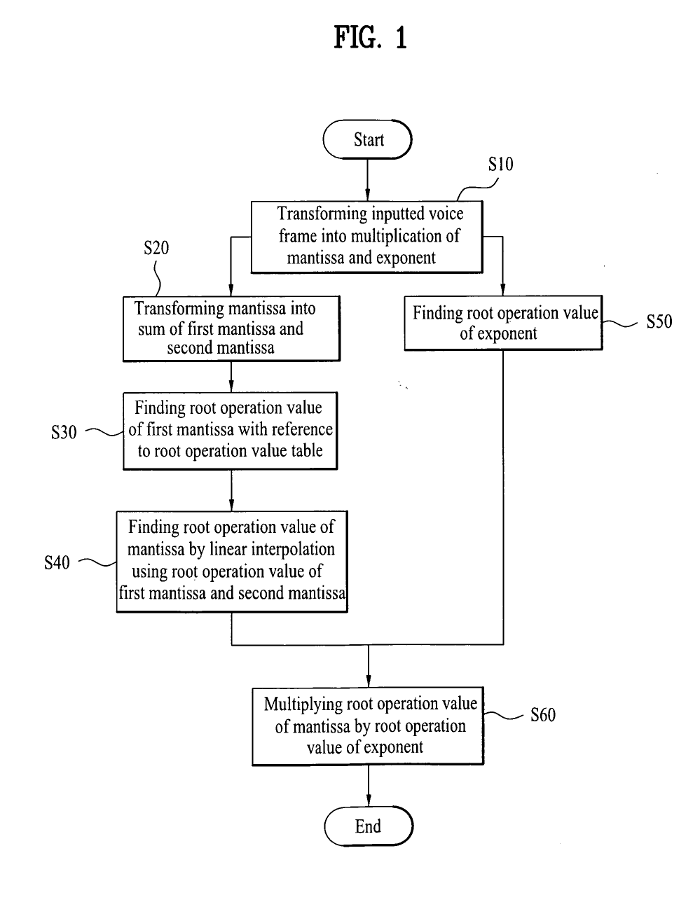

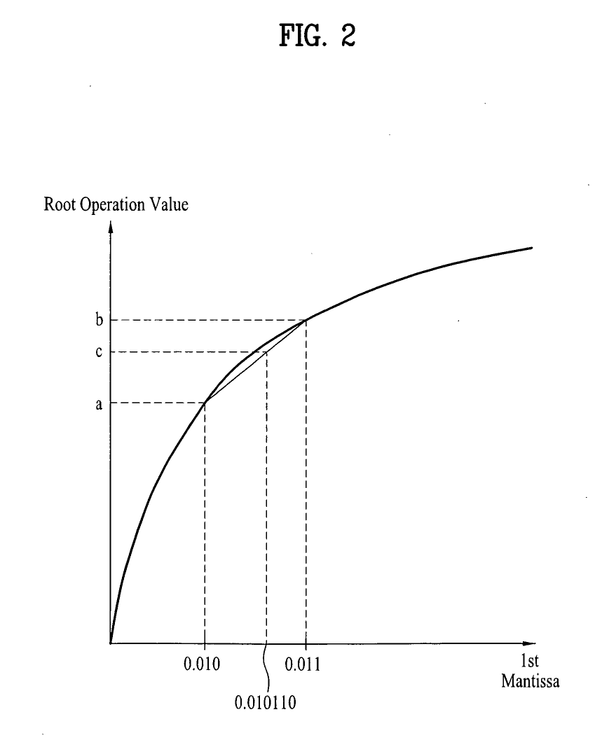

A root operation method using linear interpolation according to the present invention is explained with reference to FIG. 1 and FIG. 2 as follows.

FIG. 1 is a schematic flowchart of a root operation method using a linear interpolation according to the present invention and FIG. 2 is a graph for explaining a root operation method using a linear interpolation according to the present invention.

Referring to FIG. 1 and FIG. 2, if an 8-bit binary voice frame is inputted, the inputted frame is converted to a multiplication of a mantissa having a value between 0.0 and 1.0 and an exponent having an even exponent (S10).

For instance, if a voice frame having a value of ‘00010110’ is inputted, it is able to convert the inputted frame to one of “0.010110×2⁶”, “0.00010110×2⁸”, “0.0000010110×2¹⁰”, etc. Preferably, “0.010110×2⁶” having a greatest mantissa is selected as the multiplication.

Subsequently, the converted frame is divided into a mantissa and an exponent. A root operation is performed on each of the mantissa and the exponent. The operated values are multiplied together (i.e., √(0.010110)×√(2⁶)) to operate a final root operation value (i.e., √(00010110)) of the voice frame. This operation is explained in detail as follows.

1) Root Operation of Mantissa (‘0.010110’)

First of all, a root operation of a mantissa (i.e., √(0.010110)) is explained as follows.

The mantissa is transformed into a sum of a first mantissa having a value equal to or greater than prescribed decimals and a second mantissa having a value smaller than the prescribed decimals (S20).

The prescribed decimals are adjustable by a user's selection according to a necessity. In the following description of the embodiment according to the present invention, the prescribed decimals are assumed as three decimals. In case that a higher accuracy of a root operation is required, the prescribed decimals may be set to four decimals or higher.

In case that the mantissa is ‘0.010110’ for example, the mantissa is transformed again into a sum of a first mantissa over three decimals and a second mantissa below three decimals, i.e., ‘0.010+0.000110’. The first mantissa is used in searching a table of a root operation for a corresponding value. And, the second mantissa is used for linear interpolation, which is explained later.

As mentioned in the foregoing description, if three decimals are used in representing the mantissa as the sum of the first mantissa and the second mantissa, Table 1, in which root operation values corresponding to value of the three decimals are arranged, respectively, should be prepared in advance.

TABLE 1

| 1^{st} Mantissa | Root Operation Value |
|---|---|
| 0.000 | 0 |
| 0.001 | √0.001 ≈ 0.0101 . . . |
| 0.010 | √0.010 ≈ 0.1000 . . . |
| | (Hereinafter named “a”) |
| 0.011 | √0.011 ≈ 0.1001 . . . |
| | (Hereinafter named “b”) |
| 0.100 | √0.100 ≈ 0.1010 . . . |
| 0.101 | √0.101 ≈ 0.1100 . . . |
| 0.110 | √0.110 ≈ 0.1101 . . . |
| 0.111 | √0.111 ≈ 0.1110 . . . |

By referring to Table 1, ‘a’ is found as a root operation value of the first mantissa (i.e., ‘0.010’) (S30).

Subsequently, an accurate root operation value of the mantissa (i.e., ‘0.010110’) is operated by performing a linear interpolation, as shown in FIG. 2, using the root value of the first mantissa and the second mantissa (S40).

Since a root operation value of a value 1-step greater than the first mantissa, i.e., ‘0.011’ is ‘b’, it can be known that a root operation value of the mantissa (‘0.010110’) has a value corresponding to one of values that are greater than ‘a’ but smaller than ‘b’. By the linear interpolation, a root operation value ‘c’ of the mantissa of the present invention amounts to ‘a+(b−a)*0.000110/(0.011−0.010)’.

2) Root Operation of Exponent (‘2⁶’)

A root operation of an exponent (i.e., √(2⁶)) is much simpler than that of the mantissa. This is because the exponent is determined to be an even number. For instance, a root operation value of 2^{2d} becomes 2^{d}.

Hence, a rot operation value of the exponent ‘2⁶’ is ‘2³’ (S50).

3) Final Root Operation Value of Voice Frame (‘00010110’)

As mentioned in the foregoing description, the root operation value of the mantissa and the root operation value of the exponent are calculated as ‘c’ and ‘2³’, respectively.

Hence, a final root operation value (i.e., √(0.010110)) of the inputted 8-bit voice frame becomes c×2³ (S60).

In the above description, the root operation method using the linear interpolation according to the present invention is explained.

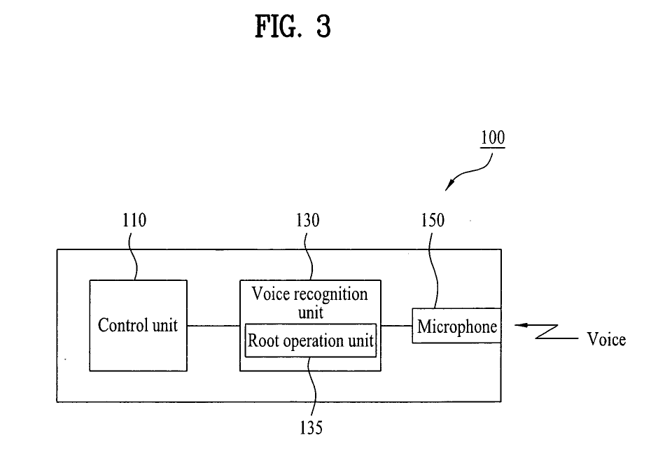

In the following description, a mobile terminal capable of implementing the root operation value is explained with reference to FIG. 3. It is preferable that the root operation method is applied to a mobile terminal capable of voice recognition. So, it is assumed that a mobile terminal according to the present invention is provided with a voice recognition function.

FIG. 3 is a schematic block diagram of a mobile terminal capable of implementing a root operation method using a linear interpolation according to the present invention.

Referring to FIG. 3, a mobile terminal 100 according to the present invention includes a control unit 110, a voice recognition unit 130 and a microphone 150.

The control unit 110 plays a role in controlling the mobile terminal 100 overall. And, the voice recognition unit 130 plays a role in recognizing a voice inputted to the microphone 150.

A root operation unit 135 of the voice recognition unit 130 is configured to implement the aforesaid root operation using the linear interpolation according to the present invention. In FIG. 3, the voice recognition unit 130 is configured separate from the control unit 110. Alternatively, the voice recognition unit 130 can be built in one body of the control unit 110.

Accordingly, the present invention provides the following effects or advantages.

First of all, since the root operation method according to the present invention uses the linear interpolation, accuracy of the present invention may be lower than that of the related art method using Taylor series or table. Yet, the root operation in the feature vector extracting process of the voice frame in the voice recognition system is able to guarantee sufficient operations against error to some extent. Hence, the present invention is usefully applicable to a voice recognition available mobile terminal and the like since the root operation method according to the present invention has an operational speed faster than that of the related art Taylor series using method and needs a memory size smaller than that of the related art table using method.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of a root operation for voice recognition, comprising:
transforming an inputted frame of prescribed bits into a multiplication of a mantissa part having a value equal to or greater than 0 under 1 and an exponential part having an even exponent;
finding a root operation value of the mantissa part using both a linear interpolation technique and a table-using technique;
finding a rot value of the exponential part; and
outputting a multiplication of the mantissa part root value and the exponential part root value as a root value corresponding to the inputted frame of the prescribed bits.

2. The method of claim 1, wherein finding a root operation value of the mantissa part comprising:
transforming the mantissa part into a sum of a first mantissa part having a value equal to or greater than prescribed decimals and a second mantissa part having a value smaller than the prescribed decimals;
finding a first root value corresponding to the first mantissa part and a second root value differing from the first root value by 1 step from a prepared root operation table; and
finding a root value corresponding to the mantissa part based on linear interpolation between the first and second root values using the second mantissa part.

3. The method of claim 1, wherein the inputted frame of the prescribed bits is a 32-bit binary frame.

4. The method of claim 1, wherein the even exponent of the exponential part is decided to have the value of the mantissa part become a greatest value between 0 and 1.

5. A mobile terminal, which is capable of implementing a root operation, the mobile terminal, comprising a root operation unit transforming an inputted frame of prescribed bits into a multiplication of a mantissa part having a value equal to or greater than 0 under 1 and an exponential part having an even exponent, the root operation unit finding a root operation value of the mantissa part using both a linear interpolation technique and a table-using technique, the root operation unit finding a root value of the exponential part, and the root operation unit outputting a multiplication of the mantissa part root value and the exponential part root value as a root value corresponding to the inputted frame of the prescribed bits.

6. The mobile terminal of claim 5, wherein the root operation unit finds the root operation value of the mantissa part in a manner of transforming the mantissa part into a sum of a first mantissa part having a value equal to or greater than prescribed decimals and a second mantissa part having a value smaller than the prescribed decimals, finding a first root value corresponding to the first mantissa part and a second root value differing from the first root value by 1 step from a prepared root operation table, and finding a root value corresponding to the mantissa part based on linear interpolation between the first and second root values using the second mantissa part.

7. The mobile terminal of claim 5, wherein the inputted frame of the prescribed bits is a 32-bit binary frame.

8. The mobile terminal of claim 5, wherein the even exponent of the exponential part is decided to have the value of the mantissa part become a greatest value between 0 and 1.

9. The mobile terminal of claim 5, wherein the mobile terminal is capable of voice recognition.
